(19) United States
(12) Patent Application Publication
(10) Pub. No.: US 2022/0286519 A1
(43) Pub. Date: Sep. 8, 2022

(54) METHOD AND SYSTEM FOR DYNAMIC VALUATION OF MEMBER DATA IN A NETWORK

(71) Applicant: Valence Enterprises, Inc., Santa Monica, CA (US)

(72) Inventor: Guy Primus, Santa Monica, CA (US)

(73) Assignee: Valence Enterprises, Inc., Santa Monica, CA (US)

(21) Appl. No.: 17/688,765

(22) Filed: Mar. 7, 2022

Related U.S. Application Data
(60) Provisional application No. 63/157,078, filed on Mar. 5, 2021.

(51) Int. Cl. H04L 67/306; G06K 9/62

(52) U.S. Cl. CPC H04L 67/306; G06K 9/6267

(57) ABSTRACT

There are provided methods and systems for dynamically valuating member data from a network in order to promote and/or enhance ties between nodes of the network. For example, there are provided a system and method for dynamically ranking career-themed social media posts among community members in order to create a career map.

### CROSS-REFERENCE TO RELATED APPLICATIONS

This application claims benefit to U.S. Provisional Patent Application No. 63/157,078, filed on Mar. 5, 2021, the disclosure of which is incorporated herein in its entirety by reference.

### BACKGROUND

The Internet has revolutionized the way we communicate, the way we study, and the way we do business, to name a few spheres where its influence is noteworthy. The backbone of this revolution is a wealth of information that is readily available for consumption. This information can be dynamic as it can readily be updated and categorized.

This abundance of readily available dynamic information has given rise to systems and methods that are configured to provide insights that enabled a wide range of business or technological practices which heretofore relied on traditional data analytics and information gathering methods. For example, when considering digital advertising, algorithms and their underlying hardware components (hereafter “systems”) have been designed and deployed to analyze social network data in order to precisely identify a cluster of members in the network; based on the analyzed data, members in the identified cluster are deemed by the systems as likely to be responsive to the ad.

Algorithms and their underlying hardware components are thus becoming an essential part in generating valuable insights from digital information in a network. Stated otherwise, algorithms and their underlying hardware counterparts serve to provide actionable insights from the data that are available in digital networks.

Despite their prowess, algorithms and their underlying hardware are typically not configured to understand how such networks are formed in the first place. Nor are they configured to actively determine the potential for clusters to form in the network based on the available data. For example, taking social media networks as case study, while current methods and systems can parse network member discourse for key words that match specific topics, products, etc., these methods are not capable of dynamically valuating member discourse in order to promote the formation of new clusters.

Again, relying on the advertising scenario described above, current methods and systems, for example, are not configured to promote the formation of clusters of a group of members that may be interested in one particular product. Stated otherwise, while the state-of-the-art is capable of identifying those members in the network that have similar interests (i.e., in the product), there are no provisions to promote those members to connect in order to form a cluster.

In social networks relating to career advancement and management, the ability of state-of-the-art systems to promote the formation of clusters, i.e., to promote the grouping of a subset of network nodes, would confer enhance benefits to members. For example, such ability would allow members to connect with specific individuals in order to benefit from additional opportunities that may be provided these specific individuals.

### SUMMARY

The present disclosure features one or more embodiments that are configured to mitigate or solve the aforementioned issues. Specifically, the present disclosure features a technological framework, which can be application-specific, for dynamically valuating member data from a network in order to promote and/or enhance cluster formation. An exemplary embodiment relating to an application for dynamically ranking career-themed social media posts among community members is described below. Such embodiments allow the creation of a career pathway mapping for members of the community, with the development of social connections as a means towards that end. Further below, and in the accompanying drawings, the technological framework for enabling this application is described in detail.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

FIG. 1 illustrates a process according to an exemplary embodiment.

FIG. 2 illustrates a process according to another exemplary embodiment.

FIG. 3 illustrates a computer processor according to various aspects of the present disclosure and configured for implementing the processes depicted in FIGS. 1 and 2.

### DETAILED DESCRIPTION

For additional context and clarity, definitions for several terms used herein are provided. A muse is defined as a network node (e.g., an individual that may be living or dead) who has attained some level of status according to the administrators, elders, or members of a user community. An administrator is one or more organizer or leader in the user community; this entity holds the responsibility of determining the structures, policies, and practices governing the way in which a user community functions (e.g., the way users in the community will interact). Without loss of generality, any one of a muse or an administrator or a member described below may be a machine or a set of machines programmed to achieve the above-described functions. These machines may be hardware/software constructs that are associated with an individual.

An elder is an administrator of a user community that may identify members who have attained a level of status recognition through their achievements within one or more community-identified classifications. A classification represents areas of knowledge, experience, and skill instrumental for functioning in a professional role, in a team, or in the community at large. The number of classifications of muses may correspond to those identified (i.e. three or nine), but may be any number determined by the administrators and/or elders of the user community.

A category includes a classification and a prioritization (i.e. relative ranking) of that classification for a particular user based on their anticipated career pathway. The number of categories may be less than or equal to the number of classifications. (i.e. a community may identify Categories by first listing the relative ranking, then the name of the classification. Example categories may be negotiation, finance, strategy, etc. By way of example only and not limitation, for the purpose of determining global, category, and personal rankings, category weights can be inversely related to their rankings.

A user community may be identified by demographic, psychographic, or affinity group marker, including, but not limited to race, gender, ethnicity, orientation, alumni status, life stage, regional identity, professional identity, industry, field, vocation, or avocation.

Inheritance of attributes may consist of information associated with user profiles. For instance, user profiles are augmented with data and metadata associated with their identified muses and the community engagement of posts associated with members who have identified the same or similar muses. Machine learning or other forms of artificial intelligence may be engaged to determine how and to what extent various inherited attributes factor into matching, filtering, sorting, and ranking of posts and suggestions for member connections.

One type of output from the post ranking module is a score (e.g. from 0 to 100) relating the likelihood that a particular post will be useful for the aspirational advancement of a particular user or group of users. We thus define resonance ratings, which may be calculated globally, personally, or according to a classification or a category. Resonance ratings facilitate the general tuning a user's feed, whereas the mediated engagement score array (defined below) is used for fine-tuning the order of a user's feed.

Whenever a user generates a post, an array of scores are attached to that post as metadata, which is defined as the mediated engagement score array (MESA). This array of scores is incorporated into an algorithm or machine learning component of the post ranking module to compare the relative values of the poster with the inherited attributes of other users in the community.

A message is construed to be information to the community in the form of an article, credential, text field, image, video, amplification, trend or evaluation. One of skill in the art will readily recognize that a message can be construed broadly as information being related to one or more parties. An artifact may be extracted from the user community, from a user hard drive, from the Internet, or from cloud storage, etc. Objectionable content can be flagged and members may be sanctioned.

An article can be linked from a journalistic news source or an Internet blog, for example. Established news sources which adhere to a code of ethics can be represented by a visual badge, checkmark, etc. to indicate a level of accountability to truth.

Credentials may be formal degrees or certificates from higher education institutions, formal certifications from other credentialing agencies, or informal certifications from any recognized organization (e.g. micro credentials from a Massive Open Online Course provider, professional certification training programs from Google or Microsoft, etc.). Users post credentials to signal career opportunities others may pursue to catalyze advancement in their career paths.

Text objects can be entirely original creations or they may contain quotes or paraphrases from others. Users are encouraged to attribute authorship to ideas, whether quoted or paraphrased. Images of specified file typed may be uploaded or linked. On the other hand, videos may be uploaded or linked directly from established, reputable file sharing sites.

Amplification. Similar to a retweet or a repost, an amplification constitutes the reposting of another community member post, with the only potential change being the action item. A trend may be defined as a quantitative recognition that a particular topic (which can be flagged for example as a hashtag) has reached a particular threshold for the number of posts within a particular period of time. Trends may be color coded according to orders of magnitude (e.g. Bronze, Silver, Gold, Platinum) with thresholds for trending levels relatively defined (i.e. Platinum regionally may be lower than platinum globally, or platinum on Valence may be different than platinum on LinkedIn).

An evaluation may be a qualitative assessment of an artifact whereas a global feed may indicate the strength and power of the user community based on an evaluation of number and/or frequency of user posts, along with the level and longevity of engagement of posts published by users/members. Given the detailed, purposive, and structured nature of each post, access to a universal global feed can reveal to individual user/members, administrators, and elders everything from emerging trends to interesting outliers, as well as tendencies of the community regarding when and how often various types of posts are submitted to and engaged with within various segments of the community population.

By way of example only, and not limitation, the concept of category feeds is described. That is, the ranking system of the embodiments described herein is not limited to the use of feeds. The ranking system described herein may apply in other implementations that do not rely on the use of feeds.

User/members may browse general feeds for posts of members who share similar category rankings (e.g. viewing the category feed for posts of members with Strategy ranked #2). The system may allow user/members to use advanced filters for feeds (e.g. view a feed for posts ranked highly for Finance ranked #1 and Strategy ranked #2.), thus creating a category feed.

Similarly, there may be personal feeds. Personal feeds utilize a defined algorithm or machine learning to discover and rank posts from the user community that reflect both the ranking of categories by the poster and the reader, as well as the attributes of the muses identified within the ranked categories of the poster and the reader.

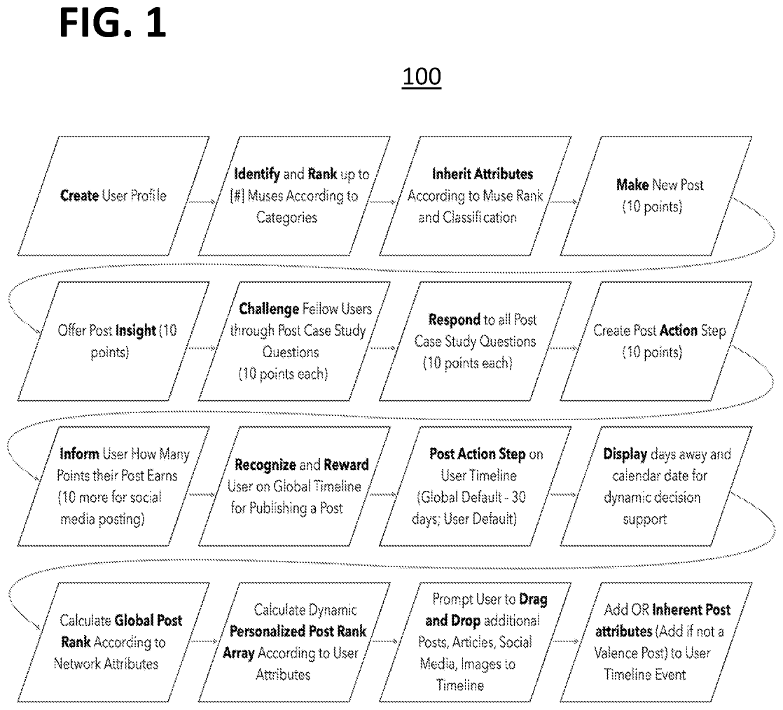

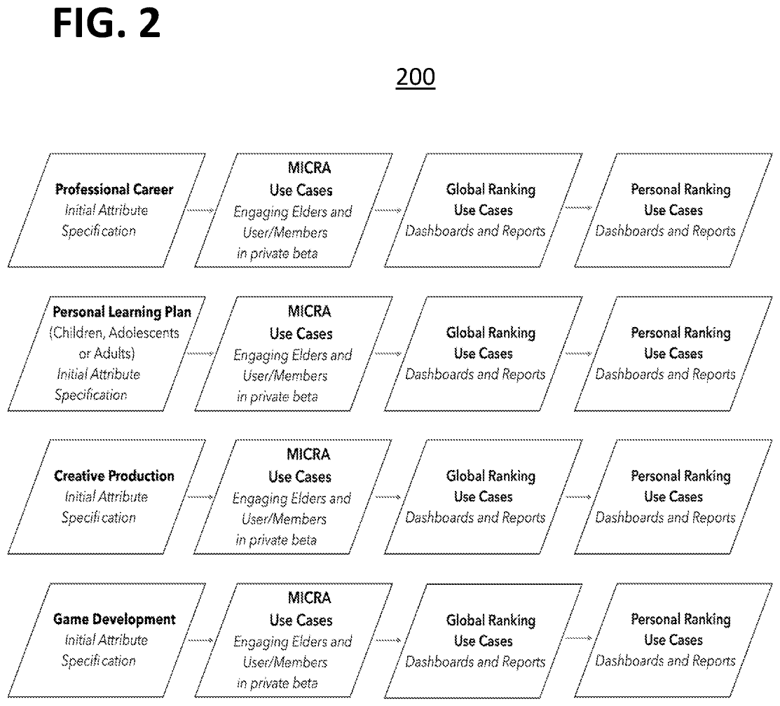

FIG. 1 and FIG. 2 describe exemplary embodiments capable of fulfilling the aforementioned advantageous functions. The systems of FIGS. 1 and 2 include (1) an initial identification of a specified number of muses for each user/member according to a specified number of classifications identified by the administrators and elders of a user community, (2) the inheritance of attributes for each muse, (3) the assigning of each muse to a category, (4) a dynamic, personalized matching and ranking algorithm of social media posts according to the inherited attributes of the user's set of identified and categorized muses, and (5) a promotion of posts with higher resonance ratings translated into an intuitive, transparent scoring system (e.g. scale from 0 to 100).

Ranking of each post for any individual user is further fine-tuned according to a mediated engagement score array (MESA) for the posting user, which tracks the level of engagement that the posting user's contributions to community dialogue have garnered as a body of work, with more weight given to posts that are (1) more recent and (2) more relevant to the browsing user, according to various profile attributes.

The exemplary embodiments of FIGS. 1 and 2 provide for the implementation of a unique process by which community members create their user profiles, which promotes a social media discourse among members to facilitate ongoing action steps toward identified career aspirations. The novel system enlists members of the community in collective reflection and documentation of key milestones for a dynamic pantheon of muses along key dimensions that have been identified as career skill sets in business and professional literature. By inheriting attributes of a limited set of muses, members are guided to community posts that are most relevant to advancing their careers.

Without loss of generality, embodiments of the exemplary system may be structured as described below. An exemplary system may include a profile creation module, implemented using one or more processors, to access a set of participant attributes for a participant. The system may further include a classification description module, implemented using one or more processors, to display a specified number of classifications (i.e. knowledge domains, such as strategy, marketing, finance, etc., assigned and described by community administrators and elders) as virtual trading cards. The system may include a muse attribute module, implemented using one or more processors, to delineate and dynamically display as a virtual trading card, an array of metadata related to each muse, along with a set of attributes associated with each classification in which a muse has demonstrated skills or experience.

The system may further include a virtual card UI module, implemented using one or more processors, to facilitate the iterative, on-screen matching and ordering of (1) a limited set of classification cards with (2) a limited set of muse cards, with which the user identifies as an exemplar of that classification, where the same muse card may, in certain instances, be matched to multiple classification cards.

The system may further include muse attributes for each muse where these attributes are represented visually as a trading card as part of a trading card set. The system may further include a muse identification and ranking module, implemented using one or more processors, to determine which muse is identified with each category and how the user ranks each category as to its relevance to the user's career aspirations, storing the set of muse-classification matches as an ordered array.

The system may include an attribute inheritance module, implemented using one or more processors, to access a set of participant attributes for a participant.

The system may include a social posting module, implemented using one or more processors, to publish an artifact, (e.g. an article, credential, text, image, video, amplification, trend or evaluation) to a community-wide, categorized, or personal timeline;

The system may include A post ranking module, implemented using one or more processors, to filter and sort posts from various members according to an algorithm.

In the exemplary system, the profile creation module may comprise an array of user attributes reflecting their career achievements, milestones, and other resume-relevant data, including, but not limited to function, industry, level, geography, experience, companies, education, etc. Furthermore, the muse ranking may be re-ordered through a drag and drop interface.

Turning now to a method of implementing the contemplated system, one embodiment may include method for dynamically valuating member data in a network. The method may include providing, by one or more processors, an array of attribute dimensions by which muse may be identified and valued within the community as instrumental to career success. The method may include providing, by one or more processors, muse-specific content and attribute data, including narrative, biographical information for one or more of the dimensions identified within the community as instrumental to career success.

In yet another embodiment, the method may include enabling user to upload or link an artifact by drag and drop, double click, right click, or control click to create a post, to provide a title to the artifact or to identify the main idea of the artifact.

The method may further include enabling a user to identify a limited number of challenges (e.g. three) posed as questions to other community members. The method may further include enabling user to provide their own responses to each of the identified challenges posed as questions. The method may further include enabling user to identify one specific action item they commit to taking in response to the artifact and identified challenges. The method may further include enabling the user to view the relative value of completing each optional annotation for the artifact in terms of how an artifact post will be ranked in global, categorical, and personal feeds. The method may further include enabling the user to view engagement statistics and actual responses and of other community members to their post.

In yet another embodiment, the method may further include providing a display feed for posts of other community members according to algorithm underlying post ranking module. The method may further include providing the display of a Resonance Rating for each post. The method may further include providing the display of a ranking for the author of each post according to the primary dimension for which the resonance rating matched the post to the user's feed.

The method may further include providing recognition of users who attain and maintain specified levels of community engagement through their posts.

In yet another embodiment, the method may include providing recognition of users within specific dimensions of expertise. The method may further include providing recognition of users within specific geographical regions. The method may further include providing recognition of users within stages of their career. The method may further include providing recognition of users according to their experience within the network (e.g. elders, newcomers, etc.)

In yet another embodiment, the method may include providing personalized content matching of professional content provided by the administrators of the user community. The method may further include providing personalized content matching of user-generated content provided by the members of the user community. The method may further include providing data analytics dashboard for user activity, community engagement, and status attainment within the community. The method may further include providing progress reports on a periodic basis, according to various embodiments (e.g. on-screen display, PDF file, email, etc.).

The method may further include providing an individualized action plan highlighting opportunities for career development. The method may further include providing actions identified from the users posted action steps. The method may further include providing suggested, potential actions identified by user posts identified as professional contacts. The method may further include providing suggested, potential actions based on actions proposed and accomplished by other community members with high resonance rankings.

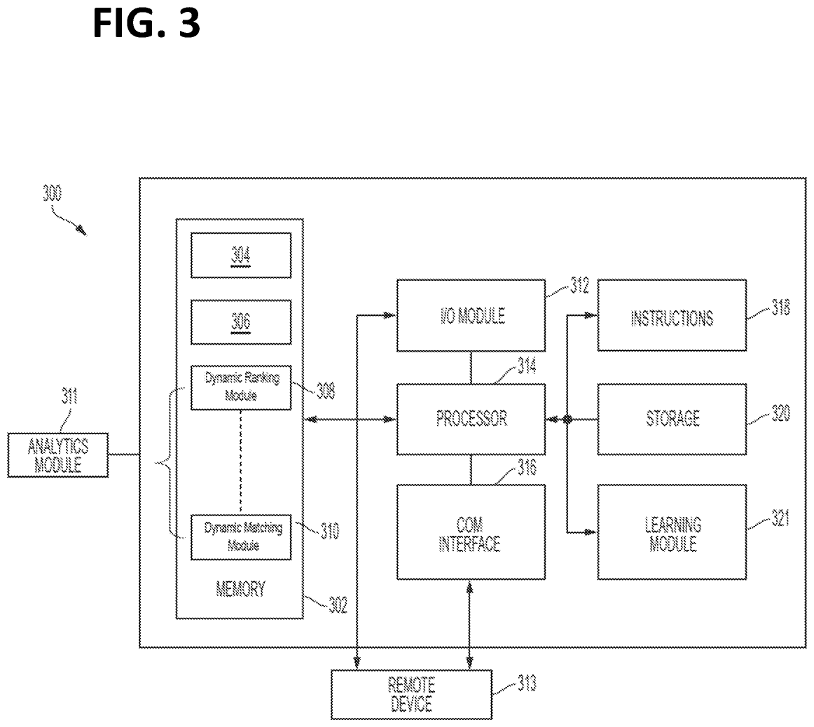

FIG. 3 illustrates a controller 300 (or computer system 300), according to the embodiments. The controller 300 can include a processor 314 having a specific structure relating to implementing the processes identified in FIGS. 1 and 2.

This application-specific structure can be imparted to the processor 314 by instructions stored in a memory 302 and/or by instructions 318 fetchable by the processor 314 from a storage medium 320 or from a remote device 313 via a communications interface 316 or an I/O module 312. The storage medium 320 may be co-located with the controller 300 as shown, or it can be remote and communicatively coupled to the controller 300. Communications between the controller and a remote device can be encrypted and/or anonymized using known methods of encryption or data anonymization.

The controller 300 can be a stand-alone programmable system, or a programmable module included in a larger system configured to interface with hardware implementing the processes illustrated in FIGS. 1 and 2.

For example, the controller 300 can be part of the PCM 400, as described previously. The controller 300 may include one or more hardware and/or firmware/software components configured to fetch, decode, execute, store, analyze, distribute, evaluate, and/or categorize information. Furthermore, the input/output (I/O) module 312 may be configured to interface with one or more devices, either wirelessly or via a wired communication bus (e.g., USB or Ethernet).

The processor 314 may include one or more processing devices or cores (not shown). In some embodiments, the processor 314 may be a plurality of processors, each having either one or more cores. The processor 314 can execute instructions fetched from the memory 302, i.e. from one of memory modules 304 and 306.

By way of example, the processor 314 may also execute instructions fetched from an analytics module 311. The analytics module 311 can include a dynamic ranking module 308 and a dynamic matching module 310. Thus, a subset of the memory instructions may embody one or more of the methods or processes described herein with respect to dynamically valuating member data from a network and/or relating to an application for dynamically ranking career-themed social media posts.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

What is claimed is:

1. A system for use with a network including a plurality of users:
a processor;
a memory comprising instructions stored thereon which when executing by the processor cause the processor to perform operations including:
creating a profile configured to access a set of participant attributes for a user in the plurality of users;
determining a specified number of classifications and displaying the specified number of classifications using a virtual representation;
determining and dynamically presenting the virtual representation as an array of metadata related information, along with a set of attributes associated with each classification from the specified number of classifications;
virtually organizing information by ordering a limited set of classifications from the specified number of classification associated with the user, and
identifying as an exemplar of the limited set of classifications a user with the same limited set of classifications.
